(19) United States
(12) Patent Application Publication
(10) Pub. No.: US 2019/0152617 A1
(43) Pub. Date: May 23, 2019

(54) METHOD FOR DRIVING AN AIR VEHICLE, AND AIR VEHICLE

(71) Applicant: SIEMENS AKTIENGESELLSCHAFT, München (DE)

(72) Inventors: Frank Anton, Erlangen (DE); Mykhaylo Filipenko, Erlangen (DE); Agnieszka Makowska, Fürth (DE)

(21) Appl. No.: 16/077,480

(22) PCT Filed: Feb. 10, 2017
(86) PCT No.: PCT/EP2017/052958

§ 371 Date: Aug. 12, 2018

(30) Foreign Application Priority Data
Feb. 12, 2016 (DE) 10 2016 202 195.8

(51) Int. Cl. B64D 31/00; B64D 27/02; B60L 15/00; H02P 17/00; H02K 51/00; H02K 11/00; H02K 11/33

(52) U.S. Cl. CPC B64D 31/00; B64D 27/02; B60L 15/007; H02P 17/00; B60L 2200/10; H02K 11/0094; H02K 11/33; B64D 2027/026; B60L 2210/20; H02K 51/00

(57) ABSTRACT

The invention relates to a method for driving an air vehicle using a multilevel converter with at least two converter modules. A first operating voltage is applied to at least one of the converter modules in a first operating state, and a second operating voltage which is lower than the first operating voltage is applied to the converter module in a second operating state. The air vehicle is designed to carry out such a method and comprises an electric drive which has at least one multilevel converter with at least two converter modules, each of which is designed and connected so as to be supplied with a first operating voltage in a first operating state and with a second operating voltage which is lower than the first operating voltage in a second operating state. Advantageously, the air vehicle is an airplane, in particular a hybrid electric airplane.

The invention relates to a method for driving an aircraft and to an aircraft.

Electrical aviation has become increasingly significant in recent times. Series hybrid drive systems are in particular the subject of active development in electrical aviation. In the case of such hybrid drive systems, electrical energy is additionally generated and supplied to an electric motor by way of a generator that is coupled to a combustion engine. The generator may thus compensate, where necessary, for drainage of an electrical energy store of an electric airplane. The advantage of series hybrid drive systems is that both the electric motor and the combustion engine are able to run at different rotational speeds and the maximum power or the maximum efficiency is thereby able to be achieved in both of them for a given consumption. In order to decouple the electric motor and the combustion engine from one another, power electronics consisting of a plurality of inverters have to be inserted between the generator and the electric motor, by way of which electronics the voltage generated at the generator is able to be modulated both in terms of frequency and in terms of amplitude.

Power inverters usually have semiconductor components, in particular IGBTs and/or power MOSFETs, which are highly vulnerable to cosmic radiation. At typical cruising altitudes for airplanes of approximately 10 km, cosmic radiation constitutes a significant hazard for semiconductor components. The flux of cosmic radiation at this altitude is higher than at sea level by a factor of around 20 to 60. Inverters therefore regularly drop out on account of a highly probable failure.

It is known to circumvent this situation by way of a permanent reduction of the operating voltage at the semiconductor components or by increasing the size of the semiconductor layer. However, these measures increase the weight of inverters. The power to weight ratio (power per mass unit) is thereby greatly reduced, which may constitute an exclusion criterion in aviation. If on the other hand the thickness of the semiconductor layer is increased, the probability of failure of the semiconductor components may even be increased, as the probability of the semiconductor material interacting with cosmic radiation increases proportionally with thickness.

It is furthermore known to use semiconductor components in the form of SiC-based or GaN-based components in the case of inverters. SiC and GaN have a higher bandgap than Si, which results in a strong reduction in radiation-induced avalanche breakdown. However, SiC and GaN components are expensive, as the crystal structure of SiC and GaN is more complex than that of silicon, with the result that growing and processing these materials is made more difficult.

It is the object of the invention, then, to specify a method for driving an aircraft, which method is improved with respect to the prior art, and to specify an aircraft that is improved with respect to the prior art. In particular, the method and the aircraft are intended to enable failure-free driving of the aircraft without necessarily increasing the weight of the drive.

This object of the invention is achieved by way of a method having the features specified in claim 1 and by way of an aircraft having the features specified in claim 11. Preferred developments of the invention are specified in the associated dependent claims, the following description and the drawing.

The method according to the invention for driving an aircraft uses a multilevel inverter having at least two inverter modules. In a first operating state, a first operating voltage is applied to at least one of the inverter modules and, in a second operating state, a second operating voltage, lower than the first one, is applied to at least one of the inverter modules.

The method according to the invention is based on the inventive concept of driving an aircraft by way of a multilevel inverter connecting motors and generators, for instance, in such a way that the multilevel inverter of the aircraft is configured in a power-dimensioned manner. This means that, in a first operating state, expediently in situations in which the aircraft is not exposed to any noteworthy cosmic radiation, the inverter module(s) of the multilevel inverter are operated at a high voltage and reduced currents. However, in a second operating state, advantageously in an operating state in which the aircraft is exposed to cosmic radiation to a greater extent—for instance as soon as a required altitude is reached, a lower voltage is provided for the inverter module(s). The applied voltage and/or a blocking voltage of the semiconductor component is the dominant influencing variable on the lifetime of semiconductor components in the case of a high flux of cosmic radiation. Even in the case of voltage changes of a few tens of volts close to a threshold voltage, the charge quantity generated as a result of cosmic radiation in the semiconductor component, for instance in an IGBT, thus changes by two to three orders of magnitude at cruising altitude. This charging allows the semiconductor component to become conductive for a short time. The heat produced as a result of this then destroys the semiconductor component. According to the invention, this situation does not occur.

Expediently, in the method according to the invention, the multilevel inverter is separated electrically and mechanically into two or more inverter modules. Thus, in the case of identical currents, in each case an individual inverter module may be operated with lower voltages. The probability of semiconductor components of the inverter modules of the multilevel inverter being destroyed by cosmic radiation may thus be reduced significantly.

Advantageously, further components of aircraft drives may regularly operate with a plurality of different voltage levels. Safety during takeoff of the aircraft is expediently ensured by overdimensioning of the multilevel inverter. Safety during cruising, on the other hand, is ensured by a plurality of redundant inverter modules that function as inverters.

The method according to the invention does not require any increase in weight of the drive, and therefore also any increase in weight of the aircraft. At the same time, an increased probability of interaction with cosmic radiation is able to be avoided. The expensive use of inverter modules having semiconductor components, which are formed with SiC and/or GaN, is not necessary according to the invention.

In one advantageous development of the method according to the invention, in the first operating state, a respective first operating voltage is applied to at least two of the inverter modules and, in a second operating state, a respective second operating voltage, in each case lower than the first one, is applied to at least two of the inverter modules.

Particularly advantageously, at least the first and the second of the at least two inverter modules are designed similarly, preferably structurally identically, so as to be able to be exchanged. Thus, some inverter modules, depending on whether they are operated in the first or in the second operating state, may be connected in series or in parallel. Expediently, the multilevel inverter is a voltage intermediate circuit inverter.

Preferably, in the method according to the invention, in the first operating state, a respective first operating voltage is applied to all of the inverter modules and, in a second operating state, a respective second operating voltage, in each case lower than the first one, is applied to all of the inverter modules.

Expediently, in the method according to the invention, the first and the second operating voltage are applied in a pulsed manner, wherein the second operating voltage has longer pulse durations than the first operating voltage. In this development of the invention, the reduced voltage level is partly compensated, on the one hand, by the longer pulse duration. On the other hand, the reduced voltage level is expediently compensated by a higher current.

Preferably, in the method according to the invention, the multilevel inverter is used to convert a generated AC voltage of a generator into an AC voltage feeding a drive motor. In this development of the invention, the multilevel inverter is used to convert AC voltage, for instance for appropriate frequency adjustment between the generator and the drive motor. Expediently, the multilevel inverter is a voltage intermediate circuit inverter having submodules that are able to be switched by way of power semiconductor components. Expediently, in the method according to the invention, the power semiconductor components are switched by way of pulse width modulation or by way of another modulation.

In one advantageous development of the method according to the invention, the second operating state is implemented during or after a takeoff and/or ended before or during a landing of the aircraft. In this development of the invention, the second operating state extends entirely or primarily over the cruising phase of the aircraft. It is in precisely this phase that the multilevel inverter of the airplane is exposed to a high flux of cosmic radiation, such that, in this development of the invention, the submodule(s) are protected against cosmic radiation in the cruising phase. Furthermore, cruising does not require maximum power to be provided, as is required by the takeoff and possibly also landing phases.

In a further advantageous refinement of the method according to the invention, the power provided by way of the multilevel inverter in the second operating state amounts to at most 80 percent of the maximum power in the first operating state; the power in the second operating state preferably amounts to at most 70 percent and ideally at most 60 percent. The power required during cruising is often significantly less than during takeoff.

Advantageously, in the method according to the invention, the first operating state is implemented before and/or during at least part of the takeoff of the aircraft and/or before and/or during at least part of the landing of the aircraft. In this development of the invention, it is in precisely those flight phases in which it may become necessary to provide power immediately that a high maximum power is made possible.

Preferably, in the method according to the invention, the second operating state is implemented above a minimum altitude of the aircraft. The altitude of the aircraft above sea level is the dominant parameter for the stream of cosmic radiation to which the aircraft is exposed.

Expediently, the method according to the invention is performed in order to drive a hybrid airplane. It is precisely in the case of hybrid airplanes that the problem of converting generator power into motor power by way of inverters arises.

The advantage of such a hybrid airplane is that these power peaks are catered for by a battery, while the generator and the turbine may be configured to be considerably smaller and more economical.

The aircraft according to the invention is designed to perform a method according to the invention as described above. The aircraft according to the invention has an electric drive that comprises at least one multilevel inverter having at least two inverter modules. The at least two inverter modules are in each case designed and connected so as to be fed with a first operating voltage in a first operating state and with a second operating voltage, lower than the respective first one, in a second operating state.

The advantages of the method according to the invention explained above apply correspondingly to the aircraft according to the invention.

In one advantageous development, a control device is present in the aircraft according to the invention, which control device is designed in each case to switch the first and/or the second operating state depending on the altitude or a flight maneuver, in particular depending on a takeoff or landing procedure that is initiated or imminent. Expediently, the control device implements the method according to the invention as described above. Appropriately, the control device obtains, as input variable, a measurement, acquired by way of an acquisition means, of the altitude of the aircraft. Depending on the measurement of the altitude, the first and/or second operating state is switched.

Particularly preferably, the aircraft according to the invention is an airplane, in particular an electric hybrid airplane.

The invention is explained in more detail below with reference to an exemplary embodiment illustrated in the drawing.

In the figures:

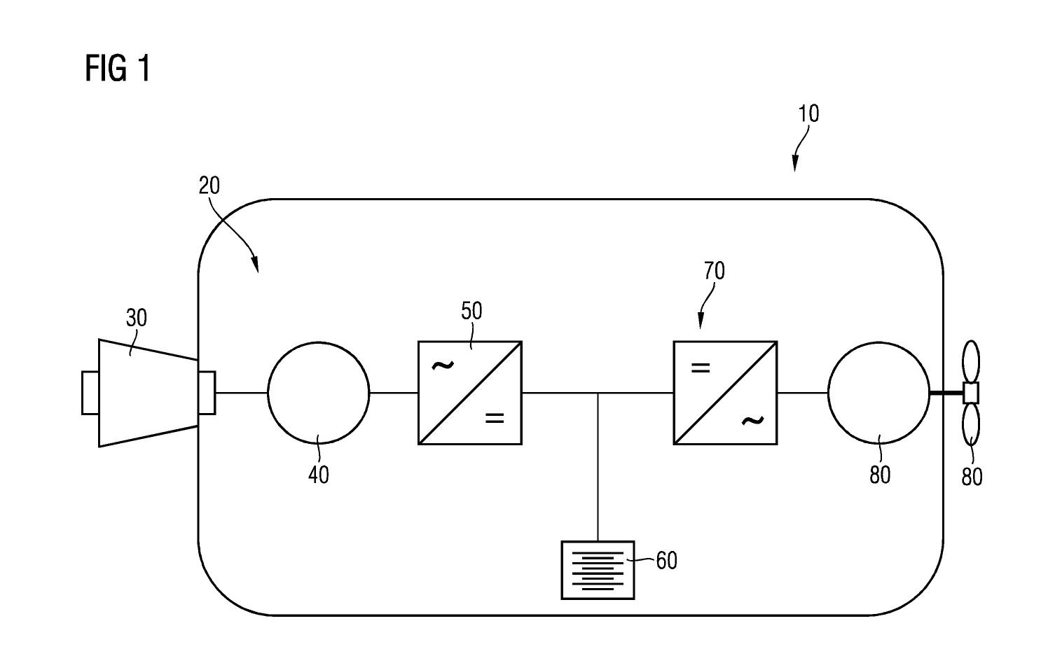

FIG. 1 schematically shows an aircraft having a drivetrain with a multilevel inverter in a block diagram,

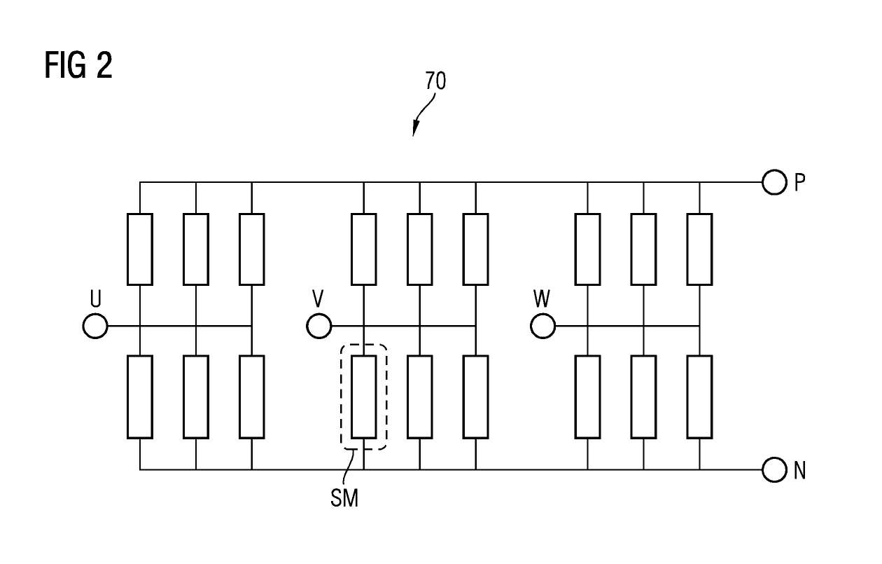

FIG. 2 schematically shows the multilevel inverter of the aircraft according to FIG. 1 in a block diagram, and

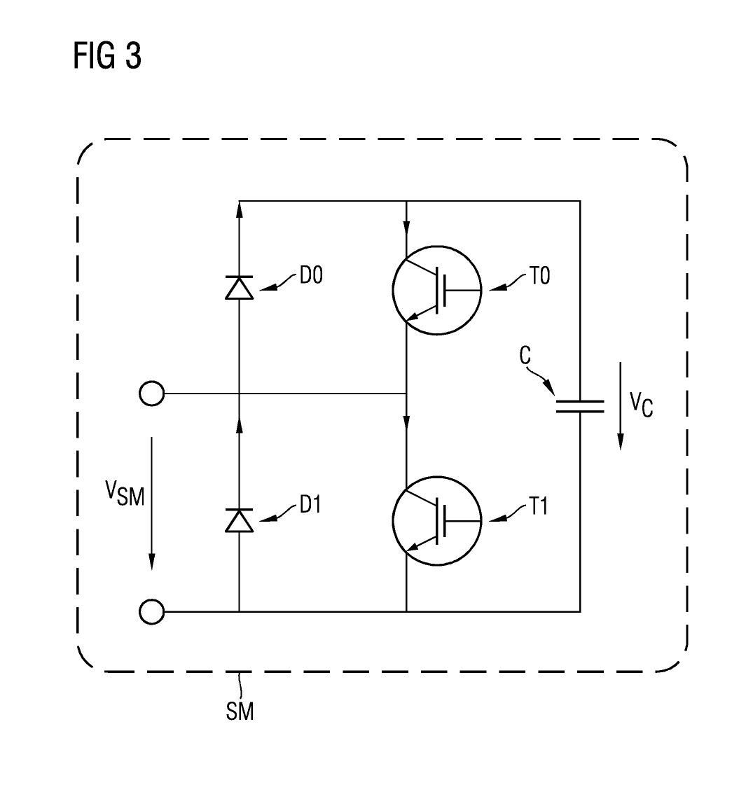

FIG. 3 schematically shows an inverter module of the multilevel inverter according to FIG. 2 in a block diagram.

The aircraft illustrated in FIG. 1 is an electric hybrid airplane 10 and has a drivetrain 20. The drivetrain 20 comprises a turbine 30, which provides mechanical rotational energy when required in a manner known per se by combustion of fuel and transmits it to a generator 40 for converting the mechanical energy into electrical energy. The generator 40 makes the electrical energy available by way of an AC voltage on the output side.

The generator 40 feeds a rectifier 50, which rectifies the AC voltage of the generator 40. Instead of a rectifier 50, in a further exemplary embodiment not illustrated specifically, an active inverter may be provided. In the event of excess energy provided by way of the generator 40, an electric battery 60 of the electric hybrid airplane 10 is charged with the rectified voltage. The battery 60 is provided as a permanent energy source for the electric airplane 10. In the event of drainage of the battery 60 or a greatly increased energy demand, the turbine 30 and the generator 40 may be called upon for the increased supply of energy.

On the output side of the rectifier 50 and the battery 60 a multilevel inverter 70 of modular construction is connected thereto, which multilevel inverter converts the DC voltage delivered by the rectifier 50 and/or the battery 60 into an AC voltage of appropriate frequency suitable for operating a propeller motor 80 of the airplane 10. The propeller motor 80 is connected mechanically to the drive of a propeller 90 of the airplane 10.

The multilevel inverter 70 constitutes a voltage intermediate circuit inverter, which (see also FIG. 3) has in each case three parallel-connected series circuits of in case two inverter modules SM per phase U, V, W. The individual inverter modules SM in each case comprise two switches T0, T1 formed by way of IGBTs (IGBT—insulated-gate bipolar transistor) with two freewheeling diodes D0, D1. In principle, in further exemplary embodiments, which otherwise correspond to the one shown, other transistors, for example power MOSFETS, may also be used as switches. The switches T0, T1 are switched by way of pulse width modulation (in principle, other modulation methods may also be used in further exemplary embodiments). The intermediate circuit voltage V_{C}, applied here to the capacitor C, of the intermediate circuit between P and N is in each case converted into the phase voltage V_{SM} of an inverter module by way of the inverter module SM.

During the flight of the airplane 10, the propeller motor 80 generally requires a highly predictable load profile: power peaks thus occur only at the beginning during a takeoff and an ascent of the airplane 10. During the rest of the flight time, in particular during cruising, only around 60% of this power is required.

Accordingly, power peaks are catered for by way of the battery 60, whereas the turbine 30 and the generator 40 have smaller dimensions.

The power fed to the propeller motor 80 is controlled by way of the multilevel inverter 70 via the current of the multilevel inverter 70, by switching voltage pulses of appropriate magnitude and length at individual semiconductor components of submodules of the multilevel inverter 70, here at the switches T0, T1.

These voltages prove to be highly critical in the case of high altitudes of the airplane 10: in principle, above a specific altitude of the airplane 10, the probability of failure of the switches T0, T1 increases greatly on account of cosmic radiation.

In this case, the probability of failure on account of cosmic radiation at such an altitude is related to the respectively applied voltage: if a specific value of the voltage is exceeded, then so much charge is generated in the semiconductor component, when the semiconductor component interacts with cosmic radiation, that it becomes conductive for a short time and is permanently destroyed by heating.

In the multilevel inverter 70 of the airplane 10 according to the invention, this problem does not occur in the method according to the invention, by way of which method the multilevel inverter 70 is controlled.

The airplane 10 is now driven by way of the method according to the invention as follows:

Since, during takeoff and during the beginning of the ascent phase, the airplane 10 still reaches a comparatively low altitude, the particle flux of the cosmic radiation at the location of the airplane 10, and therefore at the location of the multilevel inverter 70, is very small (by way of comparison: the particle flux at sea level is less than at an altitude of 12 kilometers by about a factor of 150). Consequently, the particle flux of the cosmic radiation does not pose a problem during takeoff and at the start of the ascent phase of the airplane 10.

By contrast, during cruising at an altitude of 12 kilometers, that is to say the typical cruising altitude, cosmic radiation is particularly critical: to counter it, the altitude of the airplane 10 is continuously acquired by way of a control device that is not illustrated explicitly in the drawing.

Above a threshold altitude that the airplane 10 passes after takeoff and during the ascent phase, the voltage applied to the intermediate circuit of the multilevel inverter 70, and consequently also the voltage V_{C} at the inverter modules SM of the multilevel inverter 70, is then reduced, such that the inverter modules SM are switched with voltage pulses having a reduced voltage in this operating state. In this case, the voltage pulses are switched at the same time with in each case a longer-lasting pulse duration. To provide the required power, higher currents, which are distributed over a plurality of individual, smaller submodules 200 of the multilevel inverter 70, also flow. Details of the multilevel inverter 70 are illustrated by way of example in FIG. 3.

1. A method for driving an aircraft (10), using a multilevel inverter (70) having at least two inverter modules (SM), wherein, in a first operating state, a first operating voltage is applied to at least one of the inverter modules (SM) and, in a second operating state, a second operating voltage, lower than the first one, is applied to at least one of the inverter modules (SM).

2. The method as claimed in claim 1, wherein, in the first operating state, a respective first operating voltage is applied to at least two of the inverter modules (SM) and, in a second operating state, a respective second operating voltage, in each case lower than the first one, is applied to at least two of the inverter modules (SM).

3. The method as claimed in either of the preceding claims, wherein, in the first operating state, a respective first operating voltage is applied to all of the inverter modules (SM) and, in a second operating state, a respective second operating voltage, in each case lower than the first one, is applied to all of the inverter modules (SM).

4. The method as claimed in one of the preceding claims, wherein the first and the second operating voltage are applied in a pulsed manner, wherein the second operating voltage has longer pulse durations than the first operating voltage.

5. The method as claimed in one of the preceding claims, wherein the multilevel inverter is used to convert a generated AC voltage of a generator into an AC voltage feeding a drive motor.

6. The method as claimed in one of the preceding claims, wherein the power provided by way of the multilevel inverter (70) in the second operating state amounts to at most 80 percent of the maximum power in the first operating state, preferably amounts to at most 70 percent and ideally at most 60 percent.

7. The method as claimed in one of the preceding claims, wherein the second operating state is implemented during or after a takeoff and/or ended before or during a landing of the aircraft.

8. The method as claimed in one of the preceding claims, wherein the first operating state is implemented before and/or during at least part of the takeoff of the aircraft (10) and/or before and/or during at least part of the landing of the aircraft (10).

9. The method as claimed in one of the preceding claims, wherein the second operating state is implemented above a minimum altitude of the aircraft (10).

10. The method as claimed in one of the preceding claims, performed in order to drive a hybrid airplane.

11. An aircraft for performing a method as claimed in one of the preceding claims, having an electric drive (20) that comprises at least one multilevel inverter having at least two inverter modules (SM) that are in each case designed and connected so as to be fed with a first operating voltage in a first operating state and with a second operating voltage, lower than the respective first one, in a second operating state.

12. The aircraft as claimed in the preceding claim, wherein a control device is present, which control device is designed in each case to switch the first and/or the second operating state depending on the altitude or a flight maneuver, in particular depending on a takeoff or landing procedure that is initiated or imminent.

13. The aircraft as claimed in either of the preceding claims, which is an airplane (10), in particular an electric hybrid airplane (10).
